(19) United States
(12) Patent Application Publication
(10) Pub. No.: US 2008/0204267 A1
(43) Pub. Date: Aug. 28, 2008

(54) Detector/Module Integrated Emergency Signs

(75) Inventors: Lorenzo Luterotti, Gorizia (IT); Mauro MM Miheli, Treiste (IT)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/679,912

(22) Filed: Feb. 28, 2007

(51) Int. Cl. G08B 5/00

(52) U.S. Cl. 340/815.4

(57) ABSTRACT

Evacuation route signs can be mounted on smoke or fire detectors as well as manually operable alarm units. The signs can be oriented in one of a plurality of exit route indicating positions and can be illuminated in response to an alarm condition.

### FIELD

The invention pertains to evacuation route indicators. More particularly, the invention pertains to such indicators mounted on fire or smoke detectors, or, manually operable alarm indicators such as manual call points or pull stations.

### BACKGROUND

In case of fire and consequent alarm notification, an efficient building evacuation is the key to reduce life threatening situations. Panic might impact individuals' overall capacity to orient themselves and make decisions. Audio/visual systems are usually used to support occupants' safe exits from a building. It would be desirable, where possible, to provide additional evacuation route identifying information. Preferably such structures would be modular and adjustable so as to be usable in a variety of physical situations.

### BRIEF DESCRIPTION OF THE DRAWINGS

FIG. 1A illustrates a pull station or manual call point unit in accordance with the invention;

FIG. 1B is a side sectional view of the unit of FIG. 1A;

FIG. 2A illustrates two views of an ambient condition detector in accordance with the invention;

FIG. 2B is a side sectional view of the detector of FIG. 2A;

FIG. 3 illustrates an exemplary regional monitoring system in accordance with the invention;

FIG. 4A illustrates a plurality of pull stations or manual call point units as in FIG. 1A installed and indicating an evacuation route;

FIG. 4B illustrates a plurality of ambient condition detectors as in FIG. 2A installed and indicating at least one evacuation route;

FIG. 5A illustrates an alternate form of a pull station or manual call point in accordance with the invention; and

FIG. 5B illustrates a plurality of directional indicating symbols usable with the stations or units of FIGS. 1A, 2A, 5A.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

Embodiments of the invention provide visual indicia to direct individuals toward the nearest exit door or safest exit path.

Embodiments of the invention provide a visual evacuation route indication coupled to a fire detector/initiating module. A preferred embodiment of the invention includes a directionally adjustable arrow integrated into the smoke detector/initiating module. In event of an alarm, the arrow can be illuminated to give a clear indication of nearest emergency exit path. Illumination might be achieved by use of an LED and light guide as well as backlit LCDs, OLED, thin-film-transistor (TFT) displays or the like all without limitation.

The installer would point the arrow towards the closest exit door/emergency exit path during detector/module installation. In case of alarm the detector/module switches on the arrow (steady/blinking) for easier/safer evacuation.

Another embodiment of the invention might include a remotely illuminatable route indicating symbol. Illumination could be provided by backlighted LCD, OLED or the like. The symbol could be integrated into the detector/module: A fire alarm control unit could define safer evacuation paths which might differ from the shortest path based on local conditions and select which symbols to illuminate.

One preferable embodiment of the above active, solution could be incorporated in manual pull stations or call point modules which are usually placed at lower level (usually easier to see also in low visibility condition). This solution would enable the control unit to implement evacuation management features based on adaptive evacuation strategies/short message broadcasting capability. If desired, multi-segment direction indicating members could be independently illuminated with or without additional information.

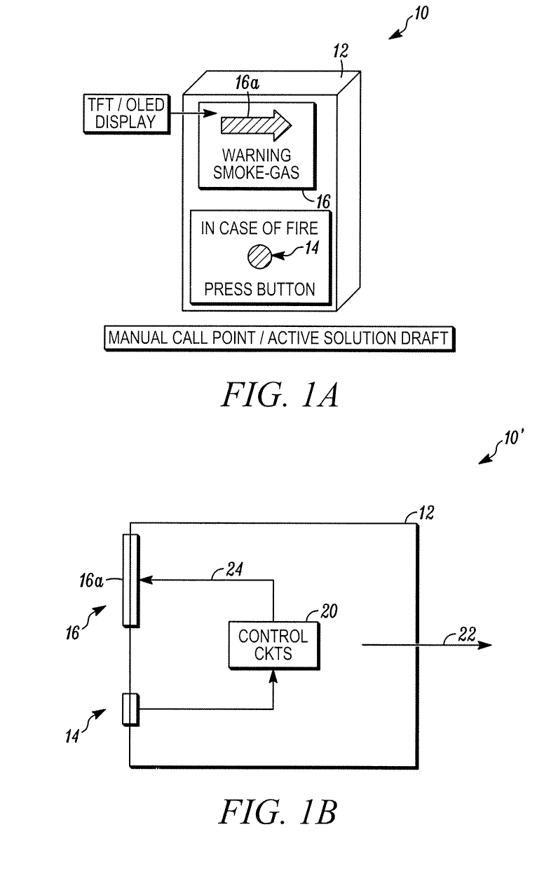

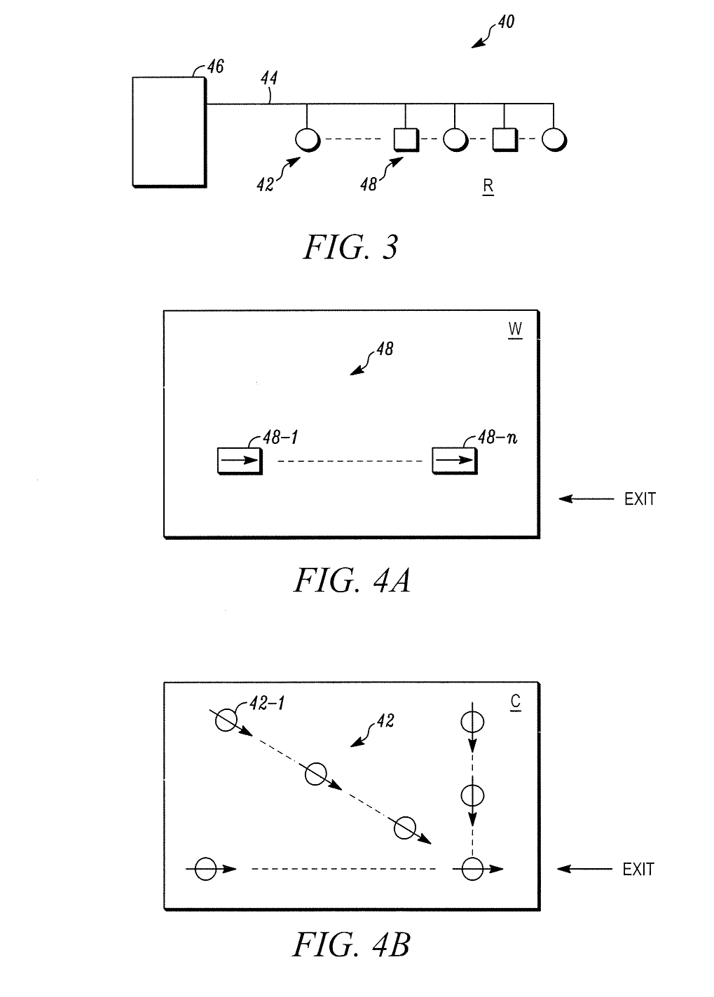

FIG. 1A illustrates a manually activated fire alarm indicating call box, or call point unit 10. The unit 10 includes a housing 12 and a manually operable member 14 such as a multidirectional movable bar, pushbutton or the like which is activated or moved by an individual to indicate the presence of an alarm condition, such as a fire. Devices such as the unit 10 are usually coupled to and are part of a regional monitoring system, best seen in FIG. 3.

The unit 10 includes a directionally adjustable evacuation route indicating sign 16 which carries an indicium 16a indicative of an exit route from the local area. The indicium 16a is set when the unit 10 is installed. The installer, for example, could orient the indicium or arrow 16a towards the closest exit door or emergency exit path.

FIG. 1B is a side sectional view of representative unit 10. FIG. 1B illustrates the activation element 14 coupled to optional control circuitry 20 which in turn can report an alarm condition via a medium 22 to the regional monitoring system. The evacuation route indicating sign 16 is illustrated in FIG. 1B carried by the housing 12.

The sign 16 can be removably attached to the housing 12 with fasteners, snap fit, screw fit or the like all without limitation during installation. As illustrated in FIG. 1B the exit route indicating indicium 16a can be illuminated via circuitry 20 and a signaling line 24 in response to the call member 14 having been activated.

It will be understood that the route indicating symbol 16a can be illuminated in response to activation of member 14. Alternately, control circuits 20 would notify a displaced system control unit. The displaced control unit could in turn determine which available route indicating symbols to illuminate. That unit can then send one or more commands to control circuits coupled to the respective symbols to be illuminated.

Representative illumination elements include light emitting diodes, or liquid crystal displays in a variety of configurations such as direct light, back light, and the like are all without limitation. Alternately, the indicium 16a can be of a non-electrically illuminated type. The asymmetrical nature of the indicium 16a makes it readily apparent as to the evacuation route from the immediate area.

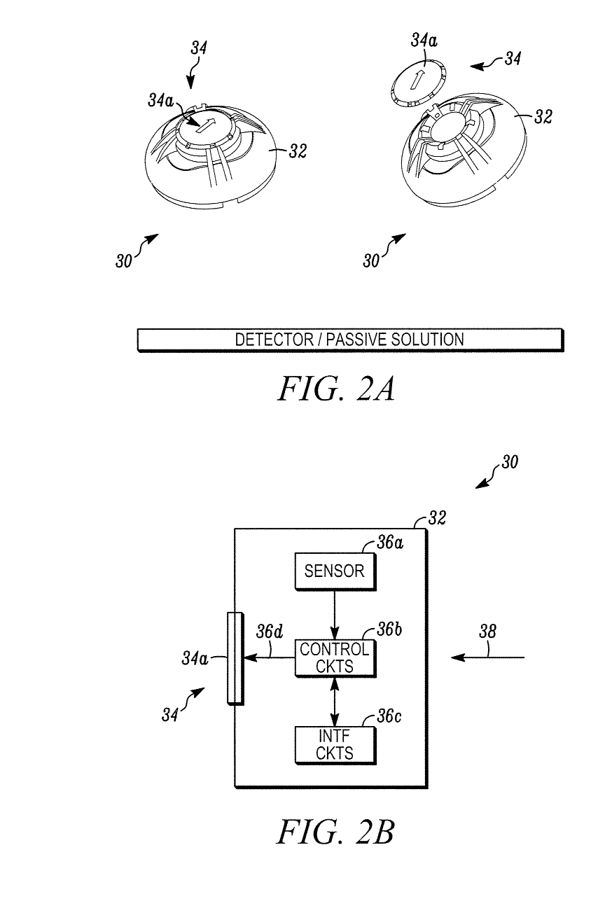

FIG. 2A illustrates two views of an ambient condition detector 30, which might be a smoke or fire detector. The detector 30 includes a housing 32 which carries an evacuation route indicating member 34 removably affixed thereto. The member 34 in turn carries an asymmetrical evacuation route indicating indicium 34a.

FIG. 2B, a side sectional view of the detector 30 illustrates an ambient condition sensor 36a, coupled to control circuitry 36b as would be understood by those of skill in the art. The sensor 36a, and control circuitry 36b are carried within the housing 32.

Control circuits 36b are in turn coupled to interface circuits 36c which can communicate via a medium 38 with a monitoring system of the type illustrated in FIG. 3. The control circuits 36b can optionally be electrically coupled to indicium 34a via a signal line 36d.

In response to an alarm condition either determined locally at the detector 30 or in response to signals received from a displaced control unit, the control unit 36b can illuminate the indicator 34a so as to provide evacuation route indicating information to individuals in the vicinity of the respective detector. Those of skill in the art will understand that the evacuation route indicating member 34 can be removably coupled to the housing 32 by a snap fit, press fit, threads, adhesive or the like all without limitation.

FIG. 3 illustrates regional monitoring system 40 which includes a plurality of detectors 42. Members of the plurality 42 could correspond, for example, to the detector 30 all without limitation. The members of the plurality of 42 communicate via a medium 44 with control circuitry or control unit 46. Those of skill in the art will understand that the control unit 46 could be implemented with one or more programmable processors and associated executable software for purposes of communicating with the members of the plurality 42.

In the exemplary system 40 a second plurality 48, of alarm indicating pull stations or call points can also be coupled to the control circuitry 46 via medium 44. Those of skill in the art will also understand that the two pluralities, the detectors 42 or the pull stations or call points 48 could be coupled via two different media to the control circuitry 46 all without limitation. The members of the pluralities 42, 48 would be distributed throughout a region R being monitored.

FIG. 4A illustrates members of the plurality 48, namely 48-1 . . . -n mounted on a wall W of the region R being monitored. As illustrated in FIG. 4A, the members of the plurality 48-1 . . . -n indicate the direction of an evacuation route via indicia, corresponding to the indicia 16a oriented toward the exit. As noted above, the indicia 16a can be illuminated or non-illuminated without departing from the spirit and scope of the present invention.

FIG. 4B illustrates members of the plurality of detectors 42 mounted on a ceiling C in the region R being monitored. The members of the plurality 42 such as 42-1 . . . -n all carry evacuation route indicating indicia, such as the indicium 34a which have been oriented so as to direct individuals in the region toward the nearby exit. The indicium 34a can be illuminated or non-illuminated, as discussed above, all without departing from the spirit and scope of the present invention.

It will also be understood that in the event that the subregion of interest has multiple exits and as a result multiple potential evacuation routes, that some or all of the members of the pluralities 42, 48 could be oriented toward different evacuation routes. In such a circumstance, assuming that the indicia were illuminated, only those associated with a predetermined evacuation route would be illuminated in the event of an alarm condition hence, a selected one of several evacuation routes could be indicated as desired or needed.

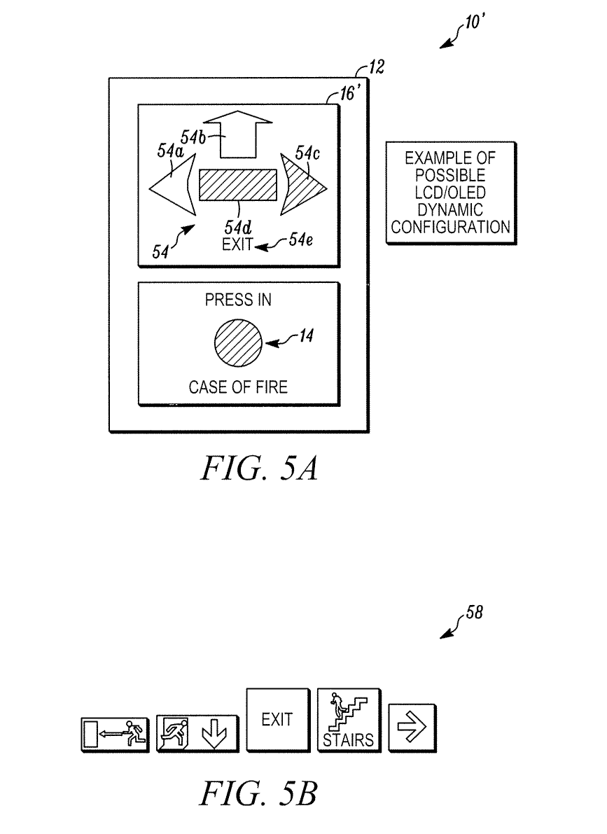

FIG. 5A illustrates an alternate form of a pull station or manual call point unit 10′. Elements of the unit 10′ which are the same as the corresponding elements of the unit 10 have been assigned the same identification numerals.

The unit 10′ includes evacuation route indicating sign 16′. The sign 16′ includes a multi-segment illuminatable element 54. The element 54 includes a plurality of separately illuminatable segments including 54a, b, c, d and e. The elements 54 could be driven via control circuits 20 and plurality of conductors, corresponding to the conductors 24 illustrated in FIG. 1B. Similar independently illuminatable elements could be incorporated into the structure 34 of detector 30.

In accordance with one embodiment of the invention, common control unit 46 could establish an appropriate evacuation route and illuminate members of the plurality 48, which could correspond to the unit 10′. In this embodiment the appropriate segment or segments such as 54c, 54d and 54e could be illuminated to provide feedback and information to individuals in the region of the unit 10′ and provide exit indicating information. The indicium 54e, namely “EXIT”, could provide a further visual statement as to the purpose of the illuminated segments 54c, 54d.

FIG. 5B illustrates additional exit indicating indicia 58 some or all of which could be incorporated into units such as the unit 10′ or the detector 30. As is the case with the sign 16′ various segments of the multi-segmented members of the plurality 58 could be illuminated, under control of the control circuits 20 for example alone or in combination with signals from the control unit 46 to provide evacuation indicating information to individuals in the immediate area.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. An evacuation route indicating structure comprising:
a base couplable to an alarm indicating unit;
exit route indicating indicia carried on the base; and
at least one illumination element carried by the base, the element illuminating at least one portion of the route indicating indicia.

2. A structure as in claim 1 where the indicia exhibits one of a plurality of orientations.

3. A structure as in claim 1 where the base can be coupled to one of an ambient condition detector, or, a manually operable alarm indicating unit.

4. A structure as in claim 2 which includes one of an ambient condition detector, or, a manually operable alarm indicating unit.

5. A structure as in claim 4 where the illumination element is coupled to the detector or the unit.

6. A structure as in claim 5 where in response to an alarm condition, the illumination element is energized.

7. A structure as in claim 1 which includes a plurality of illumination elements.

8. A structure as in claim 7 where selected of the elements can be energized to illuminate at least a portion of the indicia.

9. A regional monitoring system comprising:
a plurality of ambient condition detectors;
a common control element coupled to the detectors; and
a plurality of illuminatable route indicating signs with all members of the plurality mechanically coupled to respective detectors.

10. A system as in claim 9 where in response to an alarm condition at least some of the signs are illuminated.

11. A system as in claim 9 which includes a plurality of manually operable alarm indicating units.

12. A system as in claim 11 which includes a second plurality of illuminatable route indicating signs with all members of the second plurality mechanically coupled to respective units.

13. A system as in claim 12 where in response to an alarm condition, at least some of the signs are illuminated.

14. A system as in claim 9 where the signs each carry on asymmetrical evacuation route indicator.

15. A system as in claim 14 with the route indicators each oriented in one of a plurality of selectable positions.

16. A system as in claim 13 where the signs each carry an asymmetrical evacuation route indicator.

17. A system as in claim 12 where the signs each include multiple, different, illuminatable segments.

18. A system as in claim 17 where the control element can selectively illuminate a selected segment on each of a second plurality of units.

19. A system as in claim 18 where members of the second plurality respond to a command from the control element to illuminate the respective selected segment.

20. A system comprising:
a plurality of manually operable alarm indicating units;
a common control element coupled to the units; and
a plurality of illuminatable route indicating signs with all members of the plurality mechanically coupled to respective units.

21. A system as in claim 20 where the control element can selectively illuminate a selected segment on each of the members of the plurality of units.
